(19) United States
(12) Patent Application Publication
(10) Pub. No.: US 2025/0257635 A1
(43) Pub. Date: Aug. 14, 2025

(54) SYSTEMS, METHODS, AND APPARATUSES FOR OPTIMIZED PERFORATION CONFIGURATION MODELLING

(71) Applicant: ConocoPhillips Company, Houston, TX (US)

(72) Inventor: Kyle Friehauf, Houston, TX (US)

(21) Appl. No.: 19/044,698

(22) Filed: Feb. 4, 2025

Related U.S. Application Data
(60) Provisional application No. 63/551,170, filed on Feb. 8, 2024.

(51) Int. Cl. E21B 43/119; G01V 20/00

(52) U.S. Cl. CPC E21B 43/119; G01V 20/00; E21B 2200/20

(57) ABSTRACT

Systems, methods and devices are disclosed for optimizing a completion stage perforation configuration. Some examples includes a wellbore in a subterranean feature having one or more perforations. One or more imaging devices are operable to collect erosion image data of the one or more perforations. Moreover, one or more non-transitory storage devices store instructions which, when executed by one or more processors, cause the system to perform various operations. These operations can include determining a proppant distribution prediction based on the erosion image data. The system can use a correction equation of an erosion model to calculate a corrected uniformity index value for the proppant distribution prediction. An amount of proppant per cluster is determined in some scenarios, based on the corrected uniformity index value, to optimize a completion perforation configuration for the wellbore.

### CROSS-REFERENCE TO RELATED APPLICATIONS

The present application claims priority to U.S. Provisional Patent Application No. 63/551,170 filed on Feb. 8, 2024, which is incorporated by reference in its entirety herein.

### FIELD

Aspects of the present disclosure relate generally to systems and methods for analyzing a subterranean structure and more particularly to optimizing a perforation configuration for a completion stage of a well.

### BACKGROUND

During hydraulic fracturing, proppants are pumped through perforations in the subterranean surface. The perforations are arranged according to an initial completion design and to the extent that reservoir formation permits. Finding the right perforation design to optimize the proppant allocation is a major factor in unconventional completion engineering.

It is with these observations in mind, among others, that the presently disclosed technology was conceived.

### SUMMARY

Implementations described and claimed herein can address the foregoing problems by providing a system for optimizing a completion stage perforation configuration. The system can include one or more sensor devices operable to collect erosion data of one or more perforations of a wellbore in a subterranean feature. The system can also include an erosion model having a correction equation for calculating a corrected uniformity index value based on the collected erosion data. A proppant distribution prediction can be determined based on the corrected uniformity index value, and an amount of proppant per cluster can be determined based on the proppant distribution prediction. The system can also include a completion perforation configuration for the wellbore being optimized based on the amount of proppant per cluster.

In some examples, the proppant distribution prediction can be a first proppant distribution prediction; and/or a discrepancy between the first proppant distribution prediction and a second proppant distribution prediction. Also, the completion perforation configuration can be optimized at least partly based on organizing the discrepancy by cluster. Additionally, based on the discrepancy, the first proppant distribution prediction and the second proppant distribution prediction can indicate that the first proppant distribution prediction has a more uniform proppant distribution than the second proppant distribution prediction. The system can further include a stage level uniformity metric indicating that both the first proppant distribution prediction and the second proppant distribution prediction show a difference between two modeled perforation designs independently and in a same direction, and/or the completion perforation configuration can be optimized at least partly based on the difference being in the same direction.

In some instances, a proppant variance associated with un-eroded perforations can be calculated using the collected erosion data; and/or the proppant variance can be removed from an initial proppant allocation of the second proppant distribution prediction. Furthermore, removing the proppant variance can increase an alignment of the first proppant distribution prediction with the second proppant distribution prediction. The first proppant distribution prediction and the second proppant distribution prediction can estimate a distribution of proppant out of multiple perforation clusters in the subterranean feature. Also, the collected erosion data can include eroded dimensions of perforations after stimulation. Additionally, a quality of erosion calculations can be determined using the first proppant distribution prediction; and/or the collected erosion data can be corrected based on the quality of the erosion calculations to form corrected erosion data. Also, the amount of proppant per cluster can be determined at least partly based on the corrected erosion data.

In some examples, a device for perforation distribution modeling can include a sensor unit of a drill string operable to receive image data or acoustic data of one or more perforations of a wellbore in a subterranean feature; and/or a computing device communicatively coupled to the sensor unit for executing an erosion model, the erosion model including a correction equation for calculating a corrected uniformity index value based on the image data or the acoustic data, an erosion-based prediction of proppant allocation for the one or more perforations being based on the corrected uniformity index value, and a completion perforation configuration model for the wellbore being optimized based on the corrected uniformity index value.

In some examples, the sensor unit can include an ultrasonic sound generator. Additionally, optimizing the completion perforation configuration model can include determining, using the erosion model, an amount of proppant per cluster for the wellbore. Determining the amount of proppant per cluster for the wellbore can also include changing the amount of perforation per cluster from three to two. Moreover, optimizing the completion perforation configuration model can includes calculating a proppant variance associated with un-eroded perforations; and/or removing the proppant variance from an initial proppant allocation of the erosion-based prediction. Determining the erosion-based prediction of proppant allocation can include determining a baseline erosion assumption of a constant starting diameter based on projecting uneroded starting perforations as being a same size.

In some instances, a method of perforation distribution modeling includes receiving, from an imaging device, image data of one or more perforations of a wellbore in a subterranean feature; causing the image data to be used to determine an erosion-based prediction of proppant allocation for the one or more perforations; and/or causing a computing device communicatively coupled to the imaging device to execute an erosion model. The erosion model can include a correction equation for calculating a corrected uniformity index value based on the image data, an erosion-based prediction of proppant allocation for the one or more perforations can be based on the corrected uniformity index value, and/or a completion perforation configuration model for the wellbore can be optimized based on the corrected uniformity index value.

In some examples, optimizing the completion perforation configuration model for the wellbore can include changing, based on the erosion model, an amount of proppant per cluster in the wellbore. Optimizing the completion perforation configuration model can include calculating a proppant variance associated with un-eroded perforations; and removing the proppant variance from an initial proppant allocation of the erosion-based prediction. Optimizing the completion perforation configuration model can also include determining a quality of erosion calculations of erosion-based prediction; correcting the image data to create corrected image data based on the quality of the erosion calculations; and/or determining an amount of proppant per cluster using the corrected image data. Optimizing the completion perforation configuration model can also include forming either two perforations per cluster or three perforations per cluster in the wellbore based on optimizing the completion perforation configuration model.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example system for optimizing a perforation configuration for a well at the completion stage.

FIG. 2 illustrates an example system for optimizing a perforation configuration for a well completion stage environment using predicted proppant masses for different perforation cluster configurations.

FIG. 3 illustrates an example system for optimizing a perforation configuration for a well completion stage environment using a cross-plot.

FIG. 4 illustrates an example system for optimizing a perforation configuration for a well completion stage environment using a comparison of Uniformity Index (UI) values.

FIGS. 5A and 5B illustrate an example system for optimizing a perforation configuration for a well completion stage environment using erosion dimension predictions.

FIG. 6 illustrates an example system for optimizing a perforation configuration for a well completion stage environment using a comparison of Uniformity Index (UI) values with corrected erosion data.

FIG. 7 illustrates a flow diagram illustrating example operations of a method for optimizing a perforation configuration for a well completion stage environment, which can be performed by the systems disclosed in FIGS. 1-6 and 8.

FIG. 8 depicts an example computing system that may implement various systems and methods discussed regarding FIGS. 1-7.

### DETAILED DESCRIPTION

Aspects of the present disclosure involve systems and methods for optimizing a completion stage perforation configuration. For instance, a wellbore in a subterranean feature can have one or more perforations. One or more imaging devices can be operable to collect erosion image data of the one or more perforations. Furthermore, the system can include a distributed acoustic sensing (DAS) unit operable to collect acoustic sensing data.

The system can determine a first proppant distribution prediction based on the erosion image data. Moreover, a second proppant distribution prediction can be determined based on the sensor data such as ultrasonic data, video data, and/or combinations thereof; and/or the system can determine an amount of proppant per cluster based on the first proppant distribution prediction and the second proppant distribution prediction, to optimize a completion perforation configuration for the wellbore.

Systems and methods disclosed herein can optimize completion stage perforation configurations using an improved proppant distribution model which includes a correction equation. Finding the right perforation design to optimize the uniformity of proppant distribution can be a major factor in unconventional-terrain engineering. In the systems, methods, and devices disclosed herein, eroded dimensions of perforations after stimulation can be used by the perforation configuration model to estimate the distribution of proppant out of multiple perforation clusters in a well formation stage and can lead to improved perforation practices and well performance. Additional advantages will become apparent from the detailed description below.

In the description, phraseology and terminology are employed for the purpose of description and should not be regarded as limiting. For example, the use of a singular term, such as “a”, is not intended as limiting of the number of items. Also, the use of relational terms in the description for clarity in specific reference to the figures are not intended to limit the scope of the present inventive concept or the appended claims. Further, any one of the features of the present inventive concept may be used separately or in combination with any other feature. For example, references to the term “implementation” means that the feature or features being referred to are included in at least one aspect of the presently disclosed technology. Separate references to the term “implementation” in this description do not necessarily refer to the same implementation and are also not mutually exclusive unless so stated and/or except as will be readily apparent to those skilled in the art from the description. For example, a feature, structure, process, step, action, or the like described in one implementation may also be included in other implementations but is not necessarily included. Thus, the presently disclosed technology may include a variety of combinations and/or integrations of the implementations described herein. Additionally, all aspects of the presently disclosed technology as described herein are not essential for its practice.

Lastly, the terms “or” and “and/or” as used herein are to be interpreted as inclusive or meaning any one or any combination. Therefore, “A, B or C” or “A, B and/or C” mean any of the following: “A”; “B”; “C”; “A and B”; “A and C”; “B and C”; or “A, B and C.” An exception to this definition will occur only when a combination of elements, functions, steps or acts are in some way inherently mutually exclusive.

The technology disclosed herein can improve a set of correction equations aimed at improving the interpretation accuracy of image analysis. These systems can be an extension of an erosion-based interpretation practice with a correction for the expected deviation of proppant associated with starting perforation dimensions and erosional conditions of the well in statistics. For instance, the techniques disclosed herein can be used for image data including ultrasonic based measurement data, which may require interpretation and calculations to turn image dimensions into expected proppant quantities.

In some examples, a misalignment in proppant allocation can occur between an erosion model based on a perforation imaging analysis and other analysis techniques, such as video or ultrasonic analysis. The perforation distribution model(s) disclosed herein can expand the comparison to the entire well and offer a possible continuing explanation and/or correction for the discrepancy between these two model components.

In some examples, the model can organize the discrepancy between interpreted proppant masses by cluster. The model can determine that the corrected analysis outputs yield a more uniform proppant distribution than erosion-based outputs based on analyzing perforation images. Furthermore, the model can determine the discrepancy with cluster is random and/or with no trend suggesting that either one of the diagnostics model components is inaccurate to a large degree, or that the results need to be averaged at a larger scale for common behaviors to be identified.

In some scenarios, the perforation distribution model can determine stage level uniformity metrics indicating that both diagnostic model components showed a difference between two modeled perforation designs independently and/or in the same direction. Based on this output, the model can determine that analysis of the erosion imaging data, if averaged at the stage level, would produce the same identified completion behavior for optimization decisions. In some examples, the model can output a recommended amount of perforations per cluster as a proppant allocation optimization output, for instance, based on the determination regarding averaging the erosion imaging data. For instance, the model can indicate a predicted improvement by changing an amount of perforations per cluster (e.g., from three to two). Furthermore, quantitative uniformity metrics between the diagnostics methods can be different, and a correction to the erosion-based image analysis component can be applied.

In some examples, the difference in predicted proppant allocation between the erosion-imaging analysis and the corrected values can be partially explained by calculating the proppant allocation variance associated with un-eroded perforations and removing it from the original proppant allocation. The process can result in an increase in expected uniformity based on uncorrected erosion analysis, and this data removal can better align with uniformity metrics.

In some instances, a wider investigation into the erosion correction process can determine that erosional conditions should be analyzed on a case-by-case (e.g., well-by-well) basis to determine the quality of the erosion calculations and/or the degree that the uniformity needs correction. In some scenarios, conditions can occur where the correction is helpful to get more aligned with expected values but can still show the correct behavior in the erosion analysis without any correction. Correcting the erosion-imaging allocation component of the perforation distribution model can reduce false trends across multiple completions designs and perforation settings.

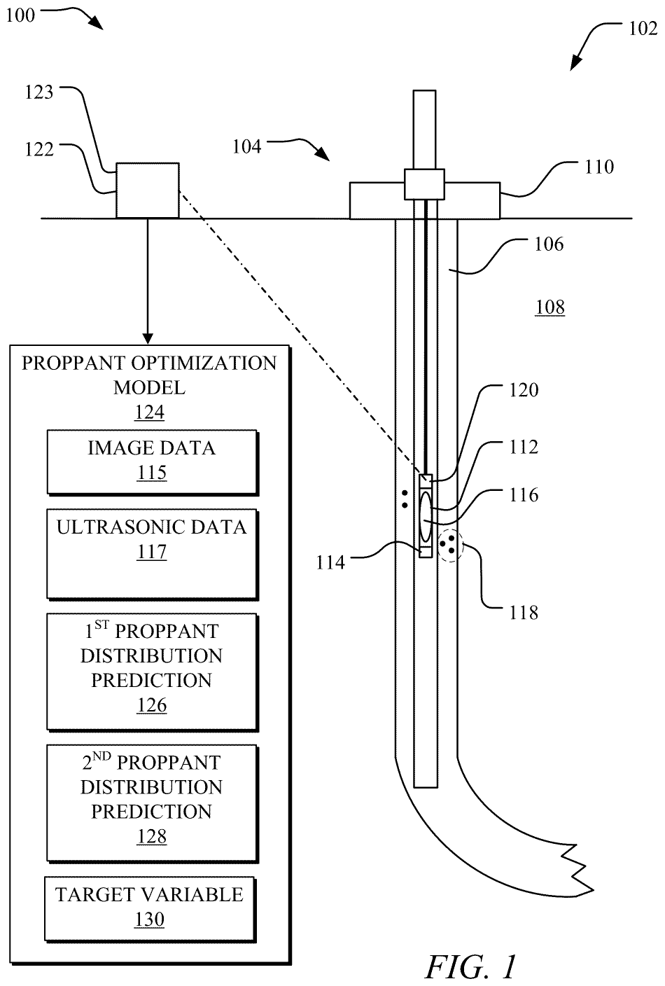

To begin a detailed discussion of an example perforation optimization modeling system, reference is made to FIG. 1.

FIG. 1 illustrates an example system 100 for optimizing a perforation configuration for a well completion stage environment 102. The well completion stage environment 102 can be a well site 104 with a bore hole 106 into a subterranean feature 108 (e.g., an underground reservoir) for extracting oil or gas from the subterranean feature 108.

In some instances, the system 100 includes a wellhead assembly 110 connected to a string assembly 112 which is inserted into the bore hole 106. The string assembly 112 can include one or more sensor units such as an imaging device 114, an ultrasonic unit 116, as well as various other sensors, hardware, and other computing device components. The imaging device 114 can include one or more of a camera or a light sensor operable to collect image data 115 in the bore hole 106, such as erosion image data of one or more perforations 118. The ultrasonic unit 116 with one or more acoustic sensors and/or actuators (e.g., speakers, microphones, etc.) can collect ultrasonic data 117 of the one or more perforations 118. The string assembly 112 can also include a wired or a wireless communication unit 120, such as a wireless transmitter, a wireless receiver, an antenna, a controller, and so of forth. The wired or wireless communication unit 120 can communicate, via a network connection, with one or more control devices 122, which can be housed at one or more center(s) 123 at surface level and/or outside the bore hole 106. The control center(s) 123 can house the control devices 122 as well as various other equipment for controlling the operations of the wellhead assembly 110 and/or the string assembly 112 to perform the perforation configuration techniques discussed herein.

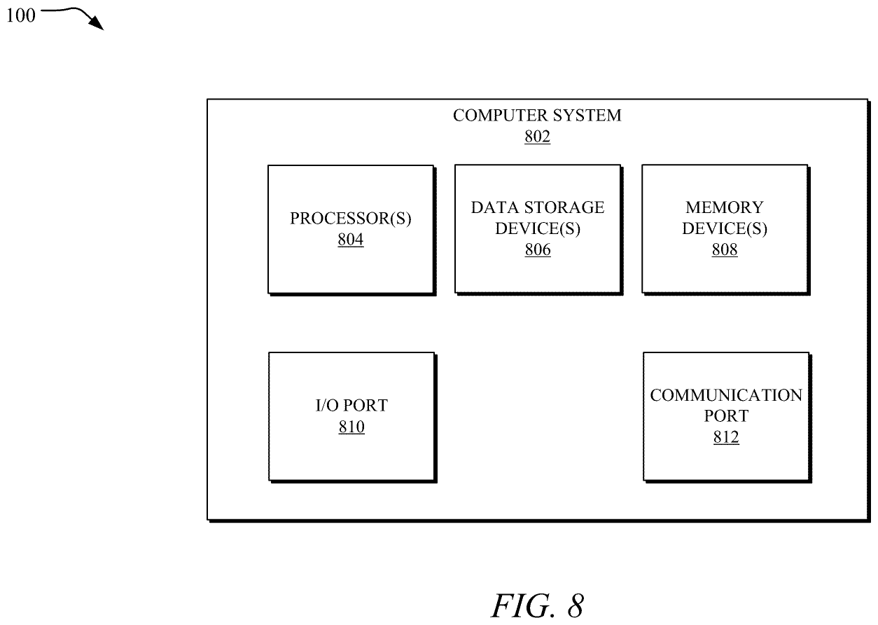

For instance, the one or more control devices 122 can include one or more computer devices (e.g., such as the computing system 802 of FIG. 8) configured to provide a proppant optimization model 124. The proppant optimization model 124 can receive and/or store the data collected at the string assembly 112, such as the image data 115 and/or the ultrasonic data 117. As discussed in greater detail below, the proppant optimization model 124 can determine a first proppant distribution prediction 126 based on the image data 115 and/or a second proppant distribution prediction 128 based on the acoustic sensing data. Furthermore, the proppant optimization model 124 can generate or determine a target variable 130 (e.g., a target output), which can include an amount of proppant per cluster, based on the first proppant distribution prediction 126 and the second proppant distribution prediction 128.

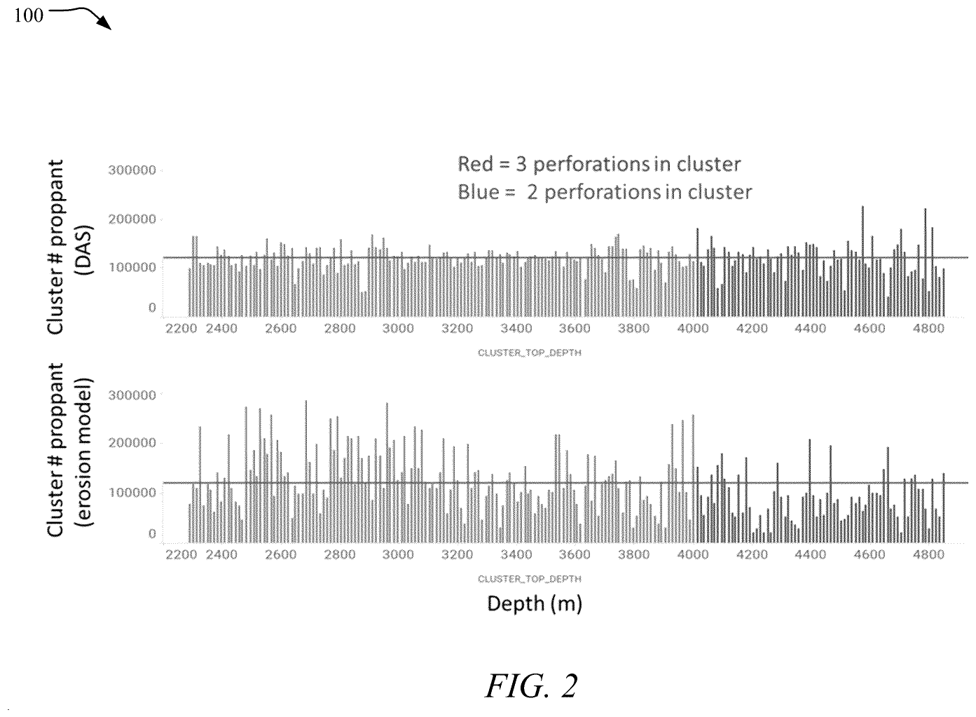

FIG. 2 depicts an example system 100 for optimizing a perforation configuration for the well completion stage environment 102, which can form at least a portion of the system 100 depicted in FIG. 1.

FIG. 2 shows an example data output of both the first proppant distribution prediction 126 and the second proppant distribution prediction 128. For instance, the data output can include predicted proppant masses for different perforation clusters using the erosion-based image proppant mass calculations for each cluster in the well, which can be compared to distributed acoustic sensing (DAS)-based proppant mass calculations for verification. The red and blue indicate the stages with 3 and 2 perforations per cluster, respectively. The horizontal black line is the average or baseline of 121,000. As such, FIG. 2 depicts an example system of interpreted proppant masses by cluster in the well site 104 from erosion modeling of perforation images. For any given stage, there can be a low chance interpreted proppant masses agree between the two diagnostics techniques.

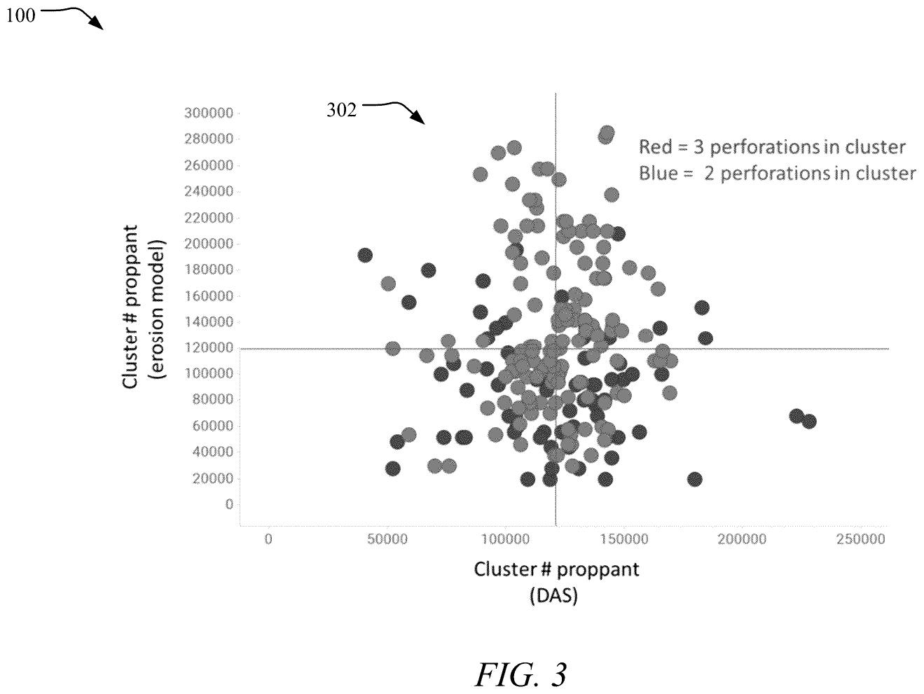

FIG. 3 depicts the proppant masses from FIG. 2 as a cross-plot 302. The cross-plot 302 can show no correlation between the diagnostics techniques. This cross-plot 302 could have resulted in a trend but not a straight line of y=x. A non-straight-line trend would indicate one of the diagnostics is over/underestimating certain technical assumptions in the process. In that case, assumptions would need to be adjusted to get better agreement. Alternatively, as shown in FIG. 3, the discrepancy can be considered random with no trend suggesting that either one of the diagnostics is inaccurate to a large degree or that the results need to be averaged at a larger scale for common behaviors to be identified. In other words, FIG. 3 depicts a cross-plot 302 analysis of examples of proppant masses by cluster in the well site 104 which compares the erosion model of perforation images to calculations from the DAS model.

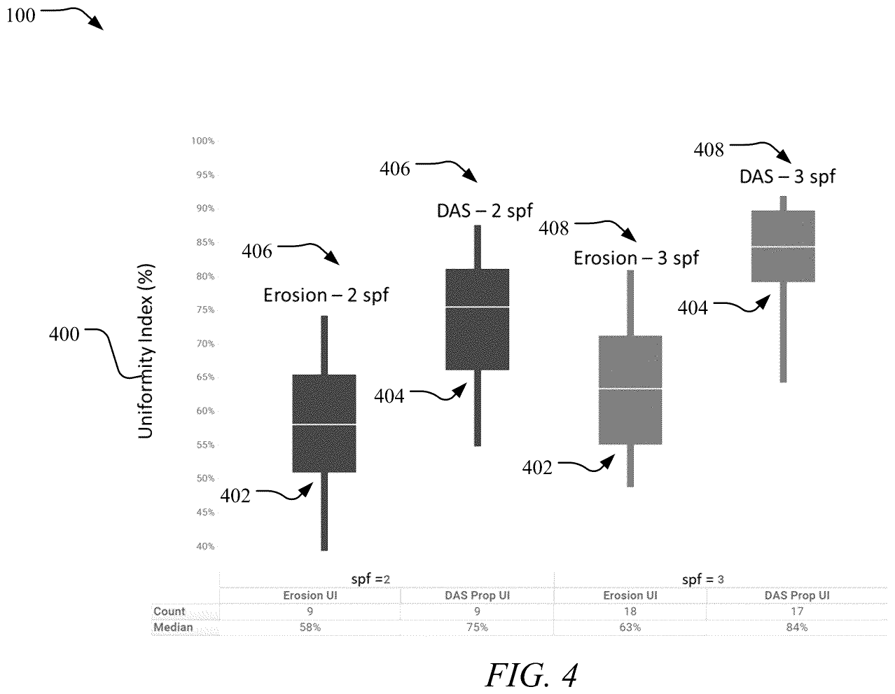

FIG. 4 depicts an example system 100 including a comparison of a Uniformity Index 400 for the well site 104 based on the image data 115 and/or the ultrasonic data 117. As shown in FIG. 4, proppant quantities at the cluster level can be combined into a stage level metric of the Uniformity Index 400.

In some instances, a comparison between an erosion-based image analysis 402 and a DAS-based analysis 404 can be split into two perforations-per-cluster designs 406 and three perforations-per-cluster designs 408, as shown in FIG. 4. The values of UI 400 can be consistently higher for the DAS-based analysis 404 than the erosion-based image analysis 402, but a trend comparing the two perforations-per-cluster designs 406 and the three perforations-per-cluster designs 408 can be seen in both diagnostic techniques, both the erosion-based image analysis 402 and the DAS-based analysis 404. The system 100 can determine that, even though cluster level quantities are not in agreement at all, either diagnostic would lead to the same trend in perforation design. In other words, in general, the trend of fluid distribution from fiber measurement can match the trends of erosion data from camera measurements. In some scenarios, other key behavior can be found to be consistent while behaviors at the lower cluster level can be lacking.

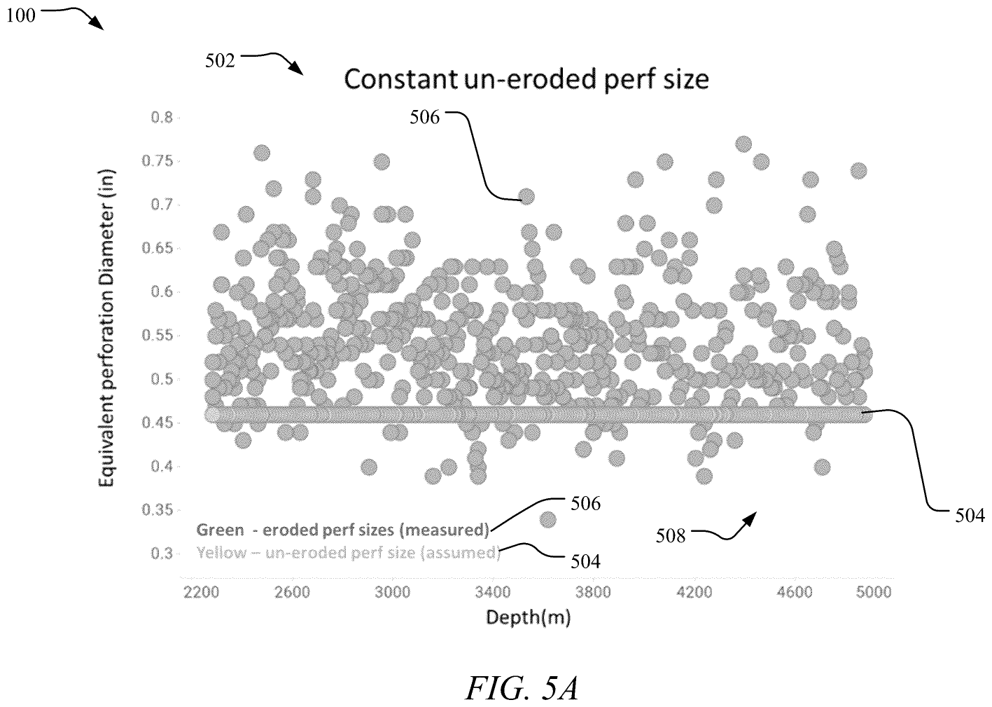

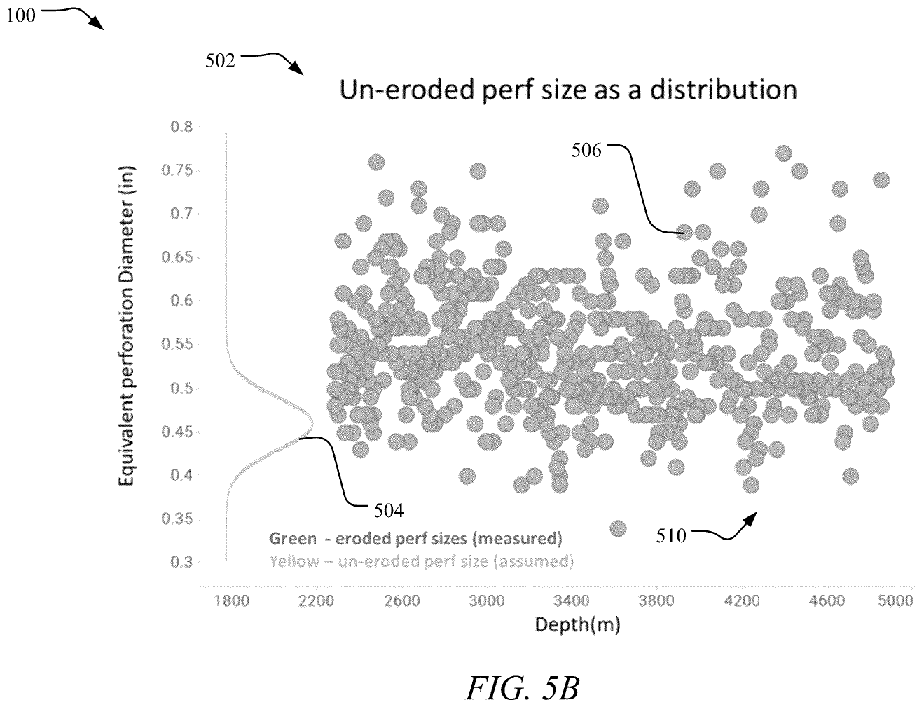

FIGS. 5A and 5B illustrate an example system 100 including a visualization 502 of un-eroded perforation dimensions 504 and eroded perforation dimensions 506 with a constant and even distribution of un-eroded perforation sizes. The system 100 depicted FIGS. 5A and 5B can form at least a portion of the system 100 depicted in FIG. 1.

In some examples, resolution between the two diagnostic techniques is likely to be explained in engineering statistics rather than scrutiny over technical assumptions. The trends can be identified in groups of common designs because they can be aggregated together to overcome randomness. General disagreement between amounts of uniformity of the interpretations can also be possibly resolved with an engineering statistical approach by suggesting that variance not necessarily associated with proppant allocation is included in the calculations of one or both diagnostics.

In some instances, the proppant optimization model 124 can focus on the erosion-based image analysis because the un-eroded perforations can provide a source of additional variance. Visually this can be seen in FIGS. 5A and 5B. FIG. 5A depicts a first chart 508 depicting the baseline erosion assumption of a constant starting diameter by projecting every un-eroded starting base perforation as the same size. FIG. 5B depicts a second chart 510 depicting a possible range of outcomes of the un-eroded perforation sizes that needs to be considered. This can be understood as a normal distribution with a standard deviation and an average. Visually with FIGS. 5A and 5B, it is shown how the proppant optimization model 124 can determine how the distribution of un-eroded holes can impact the final eroded dimensions. Some of the variance of the eroded sizes (green-measured) can be associated with the starting perforation variance, not the proppant allocation. If the proppant optimization model 124 removes the variance from the erosion analysis, the proppant optimization model 124 can get a corrected distribution projection for every stage. The correction can increase the uniformity of each stage, making it closer to the metric calculated from the image data 115 and/or the ultrasonic data 117.

In some examples, this concept can be illustrated in equation form as:

$$Variance [ proppant distribution ] = Variance [ measured in eroded perfs ] - Variance [ un - eroded perforations ]$$

These variance concepts can be expanded into the following correction equation which is in terms of an original UI calculation with constant un-eroded perforation and the perforation parameters:

$${UI}_{corrected} = 1 - \frac{\sqrt{{[ \frac{\#}{cl} ( 1 - UI ) ]}^{2} - {{spf}^{2} [ \frac{( \sqrt{2} + 1 )}{\sqrt{2 π}} \frac{1000 * {σ}_{bh}}{ER} ]}^{2}}}{\frac{\#}{cl}}$$

spf=number of perforations in cluster.
UI=Uniformity Index (UI) calculated from erosion model.
#/cl=Ib proppant per cluster (Ibm).
ER=Erosion Rate (in/1000 lbm).
bh=standard deviation of base un-eroded perforations.

This equation can provide a correction to be applied to an erosion outcome matter by correcting for the factors affecting the variance. Furthermore, this equation can assume an original UI is calculated from proppant masses of the average perforation eroded dimensions of the cluster, and not on each individual perforation. Spf can be replaced with spf if an original UI was calculated using an erosion model on each perforation instead.

In some instances, each perforation shot is not an independent and random sample of the distribution of base holes. The proppant optimization model 124 can determine that perforations in the same cluster can show less variance than a completely random sample. The second equation Spf,eq can be introduced to take this into account. Spf,eq can vary between 1 and spf and can be determined from a base hole analysis by proppant optimization model 124 of clusters by calculating the standard deviation of base holes at the cluster level vs all the perforations independently.

$$Spf , eq = {[ \frac{{σ}_{bh}}{{σ}_{bh , cl}} ]}^{2}$$

When spf,eq is used, spf can be replaced with spf*spf,eq or in the case of erosion model on each perforation cases, spf can be directly replaced with spf,eq.

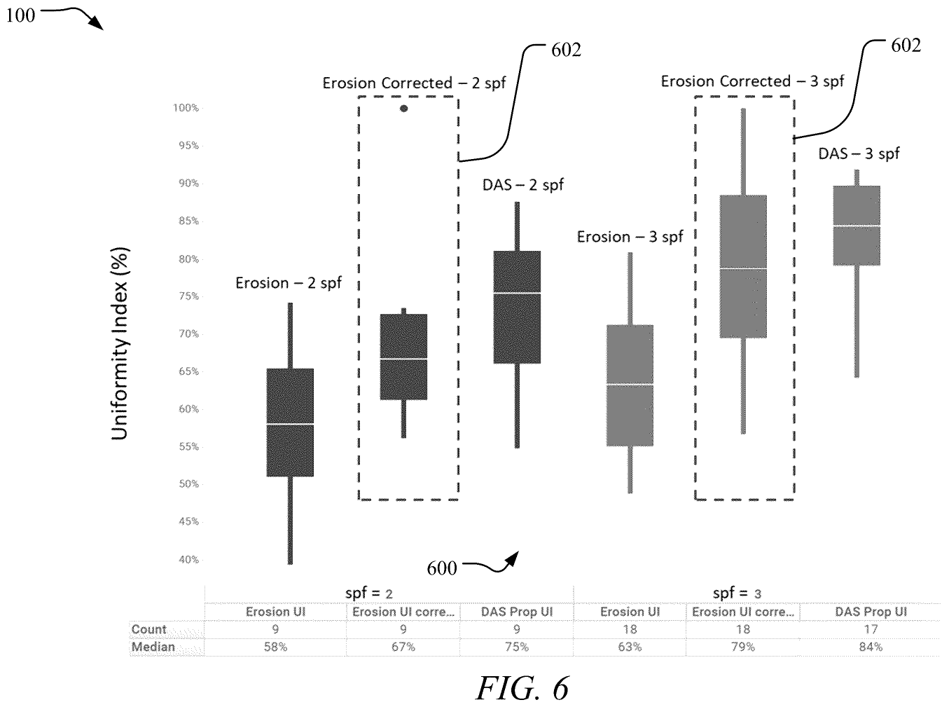

FIG. 6 depicts an example system 100 including a Uniformity Index (UI) comparison 600 for the well site 104 from the erosion model of perforation images. As shown in FIG. 6, a UI correction 602 can be added by the proppant optimization model 124. The system 100 depicted in FIG. 6 can form at least a part of the system 100 depicted in FIG. 1.

In some examples, the proppant optimization model 124 can determine a standard deviation of un-eroded perforation diameters (bh) to be 0.032 inches, and/or an erosion rate (ER) to be 0.0025 inches/1000 lbs, which can be used to correct the previously calculated UI metrics. The corrected UI values 602 are shown in FIG. 6, which can be integrated into the calculations shown in FIG. 4.

In some examples, a completion design may use a particular amount of proppant per cluster, but the quantities of UI can be much closer together when comparing the erosion corrected values 602 to the DAS values. The gap between 2 shots per foot (spf) 604 and 3 spf 606 can widen once the UI is corrected. This can be due to the 3 spf configuration 606 being a worse erosion condition than the 2 spf configuration 604 and/or by injecting less proppant per perforation. The un-eroded perforation variance can have a disproportionate effect on correction values when that is the case. The proppant optimization model 124 can further determine that original erosion UI metrics can still be higher for the 3 spf configuration 606 than the 2 spf configuration 604, but an erosion setting can minimize the difference in terms of the metric.

In some scenarios, the erosion correction can increase the UI 400, but median outcomes can still be lower for the erosion-based second proppant distribution prediction 128 than the DAS-based first proppant distribution prediction 126. In general, DAS interpretations can still be more uniform than erosion-based interpretations, even after correction. The DAS interpretations could include a similar statistical refinement which lowers the UI 400. The proppant optimization model 124 could also determine that DAS methods do have a systematic bias creating more uniformity.

In some examples, any metric calculated by the proppant optimization model 124 can show the behavior of the 3 spf configuration 606 showing more uniformity than the 2 spf configuration 604. Picking any analytical method may come to similar conclusion, even if one method calculates more uniform allocations than the other.

In some instances, the proppant optimization model 124 can use un-eroded perforation variance in a candidate selection procedure. For example, with candidate selection, a parameter (V) can be defined as a dimensionless parameter quantifying the quality of erosion conditions vs the base hole variance:

$$V = \frac{1000 * {σ}_{bh} * spf}{ER * \frac{\#}{cl}}$$

| | |
|---|---|
| 0 < V < 0.15 | Good candidate. Correction does very little change. |
| 0.15 < V < 0.25 | Good candidate. Should do correction. |
| 0.25 < V < 0.4 | Marginal candidate. Correction may be needed. |
| V > 0.4 | Bad candidate. Consider not doing erosion analysis. |

In some scenarios, the 2 spf V=0.21 (Good candidate) and 3 spf V=0.31 (marginal candidate). This can be demonstrated in FIG. 6 because both the 2 spf configuration 604 and the 3 spf configuration 606 can show a significant increase in UI 400 from correction, but the 3 spf configuration 606 can have more correction. In cases where comparison are made between 2 to 6 spf and 50,000 #/cluster, then uncorrected analysis could lead to false trends and very wide range of outcomes for the marginal or bad erosion conditions.

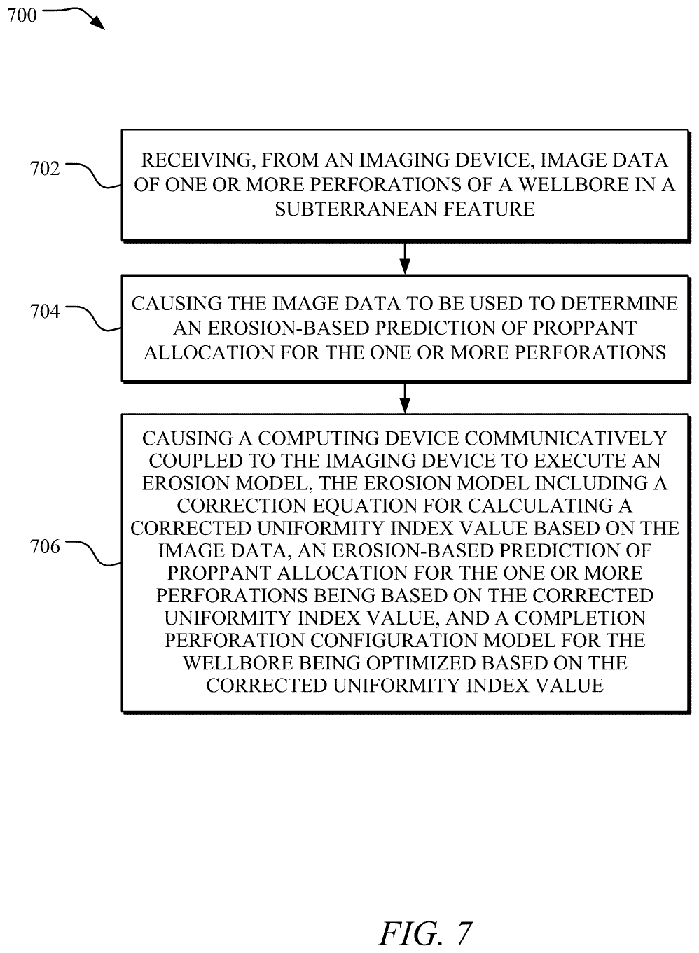

FIG. 7 depicts an example method 700 of perforation distribution modeling, which can be performed by any of the systems 100 depicted in FIGS. 1-6.

In some examples, at operation 702, the method 700 receives, from an imaging device, image data of one or more perforations of a wellbore in a subterranean feature. At operation 704, the method 700 can cause the image data to be used to determine an erosion-based prediction of proppant allocation for the one or more perforations. At operation 706, the method 700 can cause a computing device communicatively coupled to the imaging device to execute an erosion model, the erosion model including a correction equation for calculating a corrected uniformity index value based on the image data, an erosion-based prediction of proppant allocation for the one or more perforations being based on the corrected uniformity index value, and a completion perforation configuration model for the wellbore being optimized based on the corrected uniformity index value.

FIG. 8 illustrates an example computing system 802 having one or more computing units that may implement the various systems 100 and methods 700 discussed herein.

In some examples, the computing system 802 may can in included in at least one of the one or more control devices 122, the string assembly 112, the imaging device 114, the ultrasonic unit 116, the wireless communication unit 120, and/or combinations thereof. The computing system 802 may be a computing system capable of executing a computer program product to execute a computer process. Data and program files may be input to the computing system 802, which reads the files and executes the programs therein. Some of the elements of the computing system 802 are shown in FIG. 8, including one or more hardware processors 804, one or more data storage devices 806, one or more memory devices 808, and/or one or more ports 810-812. Various elements of the computing system 802 may communicate with one another by way of one or more communication buses, point-to-point communication paths, or other communication means, as discussed in greater detail below.

The processor 804 may include, for example, a central processing unit (CPU), a microprocessor, a microcontroller, a digital signal processor (DSP), a graphics processing unit (GPU) and/or one or more internal levels of cache. There may be one or more processors 804, such that the processor 804 comprises a single central-processing unit, or a plurality of processing units capable of executing instructions and performing operations in parallel with each other, referred to as a parallel processing environment.

The computing system 802 may be a computer, a distributed computer, or any other type of computer, such as one or more external computers made available via a cloud computing architecture. The presently described technology including the proppant optimization model 124 can optionally be implemented in software stored on the data stored device(s) 806, stored on the memory device(s) 808, and/or communicated via one or more of the ports 810-812, thereby transforming the computing system 802 in FIG. 8 to a special purpose machine for implementing the operations described herein. Examples of the computing system 802 can include personal computers, terminals, workstations, mobile phones, tablets, laptops, personal computers, multimedia consoles, gaming consoles, wearable devices, internet of thing devices, vehicle devices, set top boxes, and the like. As such, the computing system 802 can implement the presently disclosed technology into various practical applications.

The one or more data storage devices 806 may include any non-volatile data storage device capable of storing data generated or employed within the computing system 802, such as computer executable instructions for performing a computer process, which may include instructions of both application programs and an operating system (OS) that manages the various components of the computing system 802. The data storage devices 806 may include, without limitation, magnetic disk drives, optical disk drives, solid state drives (SSDs), flash drives, and the like. The data storage devices 806 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 808 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 806 and/or the memory devices 808, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing system 802 includes one or more ports, such as an input/output (I/O) port 810 and a communication port 812, for communicating with other computing systems, network, or devices. It will be appreciated that the ports 810-812 may be combined or separate and that more or fewer ports may be included in the computing system 802.

The I/O port 810 may be connected to an I/O device, or other device, by which information is input to or output from the computing system 802. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 802 via the I/O port 810. Similarly, the output devices may convert electrical signals received from computing system 802 via the I/O port 810 into signals that may be sensed as output by a human, such as sound, light, and/or touch. The input device may be an alphanumeric input device, including alphanumeric and other keys for communicating information and/or command selections to the processor 804 via the I/O port 810. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices can convert one form of energy or signal into another for input into or output from the computing system 802 via the I/O port 810. For example, an electrical signal generated within the computing system 802 and/or by the components of the string assembly 112 and/or the wellhead assembly 110 may be converted to another type of signal, and/or vice-versa. In one implementation, the environment transducer devices sense characteristics or aspects of an environment local to or remote from the computing system 802, such as, light, sound, temperature, pressure, magnetic field, electric field, chemical properties, physical movement, orientation, acceleration, gravity, operational machine characteristics, and/or the like. Further, the environment transducer devices may generate signals to impose some effect on the environment either local to or remote from the example computing system 802, such as, physical movement of some object (e.g., a mechanical actuator), heating or cooling of a substance, adding a chemical substance, and/or the like.

In one implementation, a communication port 812 is connected to a network by way of which the computing system 802 may receive network data useful in executing the methods and systems set out herein as well as transmitting information and network configuration changes determined thereby. Stated differently, the communication port 812 can connect the computing system 802 to one or more communication interface devices configured to transmit and/or receive information between the computing system 802 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 812 to communicate one or more other machines, either directly over a point-to-point communication path, over a wide area network (WAN) (e.g., the Internet), over a local area network (LAN), over a cellular (e.g., third generation (3G), fourth generation (4G), or fifth generation (5G)) network, or over another communication means. Further, the communication port 812 may communicate with an antenna or other link for electromagnetic signal transmission and/or reception.

In an example implementation, the proppant optimization model 124, the image data 115, the ultrasonic data 117, the first proppant distribution prediction 126, the second proppant distribution prediction 128, the target variable 130, the cross-plot 302, the UI 400, the erosion-based image analysis 402, the DAS-based analysis 404, the two perforations-per-cluster designs 406, the three perforations-per-cluster designs 408, the visualization 502, the un-eroded perforation dimensions 504, the perforation dimensions 506, the first chart 508, the second chart 510, the comparison 600, the UI correction 602, the 2 spf configuration 604, the 3 spf configuration 606, the method 700, other data files, other software, and/or other modules or services may be embodied by data files and/or instructions stored on the data storage devices 806 and/or the memory devices 808 and retrieved and/or executed by the processor 804.

The system set forth in FIG. 8 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The disclosed methods present elements of the various steps in a sample order and are not necessarily meant to be limited to the specific order or hierarchy presented.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system for optimizing a completion stage perforation configuration, the system including:
one or more sensor devices operable to collect erosion data of one or more perforations of a wellbore in a subterranean feature;
an erosion model including a correction equation for calculating a corrected uniformity index value based on the collected erosion data, a proppant distribution prediction determined based on the corrected uniformity index value, an amount of proppant per cluster being determined based on the proppant distribution prediction; and
a completion perforation configuration for the wellbore being optimized based on the amount of proppant per cluster.

2. The system of claim 1, wherein:
the proppant distribution prediction is a first proppant distribution prediction; and
a discrepancy between the first proppant distribution prediction and a second proppant distribution prediction is organized by cluster, and the completion perforation configuration is optimized at least partly based on organizing the discrepancy by cluster.

3. The system of claim 2, wherein, based on the discrepancy, the first proppant distribution prediction and the second proppant distribution prediction indicate that the first proppant distribution prediction has a more uniform proppant distribution than the second proppant distribution prediction.

4. The system of claim 2, further comprising:
a stage level uniformity metric indicating that both the first proppant distribution prediction and the second proppant distribution prediction show a difference between two modeled perforation designs independently and in a same direction, the completion perforation configuration is optimized at least partly based on the difference being in the same direction.

5. The system of claim 2, wherein:
a proppant variance associated with one or more un-eroded perforations is calculated using the collected erosion data; and
the proppant variance is removed from an initial proppant allocation of the second proppant distribution prediction.

6. The system of claim 5, wherein removing the proppant variance increases an alignment of the first proppant distribution prediction with the second proppant distribution prediction.

7. The system of claim 2, wherein the first proppant distribution prediction and the second proppant distribution prediction estimate a distribution of proppant out of multiple perforation clusters in the subterranean feature.

8. The system of claim 2, wherein the collected erosion data includes eroded dimensions of perforations after stimulation.

9. The system of claim 8, wherein:
a quality of erosion calculations is determined using the first proppant distribution prediction; and
the collected erosion data is corrected based on the quality of the erosion calculations to form corrected erosion data, the amount of proppant per cluster is determined at least partly based on the corrected erosion data.

10. A device for perforation distribution modeling, the device comprising:
a sensor of a drill string operable to receive image data or acoustic data of one or more perforations of a wellbore in a subterranean feature; and
a computing device communicatively coupled to the sensor for executing an erosion model, the erosion model including a correction equation for calculating a corrected uniformity index value based on the image data or the acoustic data, an erosion-based prediction of proppant allocation for the one or more perforations being based on the corrected uniformity index value, and a completion perforation configuration model for the wellbore being optimized based on the corrected uniformity index value.

11. The device of claim 10, wherein the sensor includes an ultrasonic sound generator.

12. The device of claim 10, wherein optimizing the completion perforation configuration model further includes determining, using the erosion model, an amount of proppant per cluster for the wellbore.

13. The device of claim 12, wherein determining the amount of proppant per cluster for the wellbore includes changing an amount of perforations per cluster from three to two.

14. The device of claim 10, wherein optimizing the completion perforation configuration model includes:
calculating a proppant variance associated with un-eroded perforations; and
removing the proppant variance from an initial proppant allocation of the erosion-based prediction.

15. The device of claim 10, wherein determining the erosion-based prediction of proppant allocation includes determining a baseline erosion assumption of a constant starting diameter based on projecting uneroded starting perforations as being a same size.

16. A method of perforation distribution modeling, the method including:
receiving, from an imaging device, image data of one or more perforations of a wellbore in a subterranean feature;
causing the image data to be used to determine an erosion-based prediction of proppant allocation for the one or more perforations; and
causing a computing device communicatively coupled to the imaging device to execute an erosion model, the erosion model including a correction equation for calculating a corrected uniformity index value based on the image data, an erosion-based prediction of proppant allocation for the one or more perforations being based on the corrected uniformity index value, and a completion perforation configuration model for the wellbore being optimized based on the corrected uniformity index value.

17. The method of claim 16, wherein optimizing the completion perforation configuration model for the wellbore includes changing, based on the erosion model, an amount of proppant per cluster in the wellbore.

18. The method of claim 16, wherein optimizing the completion perforation configuration model includes:
calculating a proppant variance associated with un-eroded perforations; and
removing the proppant variance from an initial proppant allocation of the erosion-based prediction.

19. The method of claim 16, wherein optimizing the completion perforation configuration model includes:
determining a quality of erosion calculations of erosion-based prediction;
correcting the image data to create corrected image data based on the quality of the erosion calculations; and
determining an amount of proppant per cluster using the corrected image data.

20. The method of claim 19, wherein optimizing the completion perforation configuration model includes:
forming either two perforations per cluster or three perforations per cluster in the wellbore based on optimizing the completion perforation configuration model.
